(19) United States
(12) Patent Application Publication
(10) Pub. No.: US 2003/0060239 A1
(43) Pub. Date: Mar. 27, 2003

(54) Method and apparatus to aid in viewing a portable device

(75) Inventor: Michael A. Epstein, Spring Valley, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/962,650

(22) Filed: Sep. 25, 2001

(51) Int. Cl. H04M 1/00

(52) U.S. Cl. 455/566; 345/8

(57) ABSTRACT

A portable device and method for allowing a user to read an incoming message easily on a display section of the portable device is provided. The portable device includes a means for receiving an incoming signal representing a message; a means for displaying information responsive to the received message; a means for detecting if the device is tilted over a predetermined angle; and, a means for controlling the display means to display an inverted display of the received message if the device is tilted over a predetermined angle.

### BACKGROUND OF THE INVENTION

1. Field of the Invention

The present invention relates to a portable receiver and, more particularly, to a display device whose image can be read without removing from the holding means.

2. Description of Related Art

A portable receiver, such as a pager, cellular phone, PDA, etc., includes a display screen to display text messages, or pictures received from a sending party. The display is typically mounted on the portable device. Referring to FIG. 1, portable receivers or pagers are often carried in bags or attached to a piece of clothing or the waist belt of a user. There are many commercially available holding devices that are adapted to receive the portable receivers on a part of the user's body. Frequently, users like to view the display content without removing the device from the clothing or belt, as shown in FIG. 2. However, users are often unable to read and understand the display information when looking down on the portable device attached to the body or belt as the display information is shown in upside down orientation.

Therefore, there is a need for allowing the user to read the display information on the portable receiver that is attached to the body, i.e., waist belt and neck holder, without rotating the holding device to read the display information, to eliminate the frustration associated with reading inverted messages on the display section.

### SUMMARY OF THE INVENTION

The present invention provides a portable device capable of allowing the user to read the display information easily without removing the device from the body, waist, or neck holder to which it is attached.

According to an aspect of the invention, there is provided a portable device capable of enabling a user to easily read an incoming message, which includes a receiver for receiving an incoming signal; a decoder coupled to the receiver for decoding the incoming signal to provide a decoded message; a processor coupled to the decoder for providing a control signal and an alert signal in response to the reception of the incoming signal; a sensor coupled to the processor for providing a switch signal if the device is tilted over the predetermined angle; and, a display section coupled to the processor for displaying the decoded message in response to the control signal and for displaying an inverted display of the decoded message in response to the switch signal.

According to another aspect of the invention, there is provided a method of allowing a user to easily read an incoming message on a display section of a portable device, the method includes the steps of: receiving an incoming signal representing a message; demodulating the incoming signal to produce a decoded message; determining whether the device is tilted over a predetermined angle; displaying the decoded message in a non-inverted format on the display section if the device is not tilted over a predetermined angle; and, displaying an inverted display of the decoded message if the device is tilted over a predetermined angle.

The foregoing and other features and advantages of the invention will be apparent from the following, more detailed description of preferred embodiments as illustrated in the accompanying drawings in which reference characters refer to the same parts throughout the various views. The drawings are not necessarily to scale, the emphasis instead is placed upon illustrating the principles of the invention.

### BRIEF DESCRIPTION OF THE DRAWINGS

FIG. 1 is a perspective view of a user with a portable device attached to the waistband;

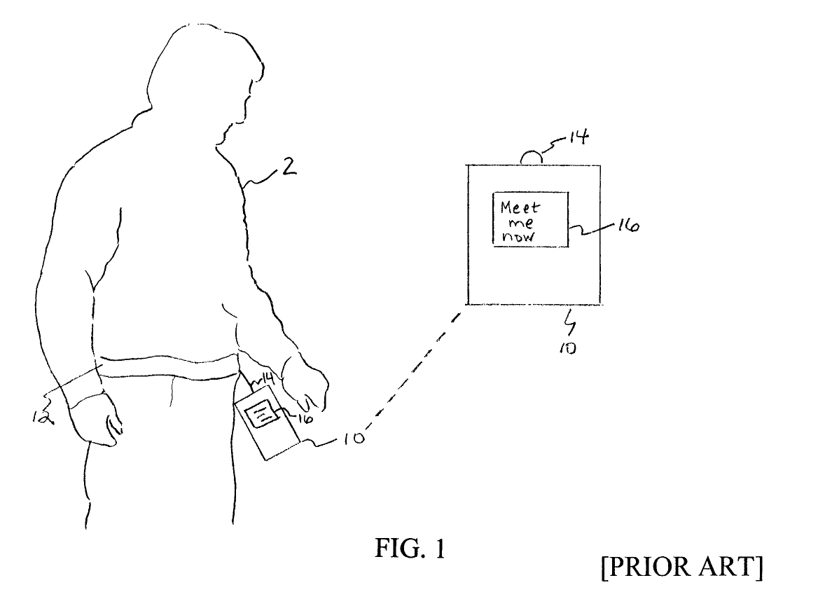

FIG. 2 is a perspective view of a user attempting to read the display information on a portable device in a conventional way;

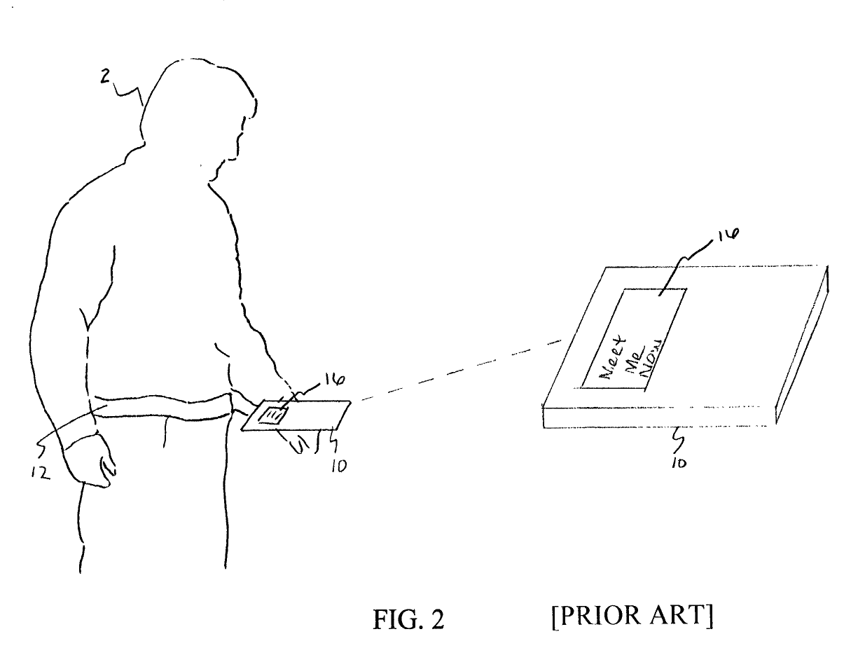

FIG. 3 is a simplified block diagram of the portable device according to an embodiment of the present invention;

FIG. 4 is a perspective view of a user attempting to read the display information on a portable device in accordance with the present invention;

FIG. 5 is a perspective view of a user with a portable device attached to the neck holder in accordance with another embodiment of the present invention; and,

FIG. 6 is a perspective view of a user with a cellular phone attached to the neck holder in accordance with another embodiment of the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. For the purposes of simplicity and clarity, detailed descriptions of well-known devices, circuits, and methods are omitted so as not to obscure the description of the present invention with unnecessary detail.

According to the principle of the present invention, the portable receiver changes the orientation of the displayed information in the display section, so that the user looking down at the receiver attached to the user's body is able to read easily the displayed information without removing or detaching the receiver from the body.

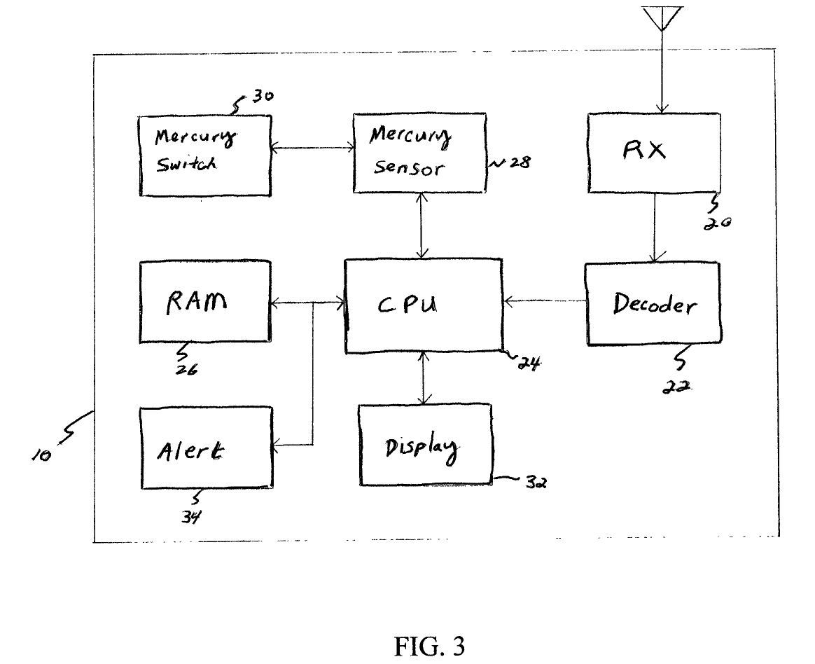

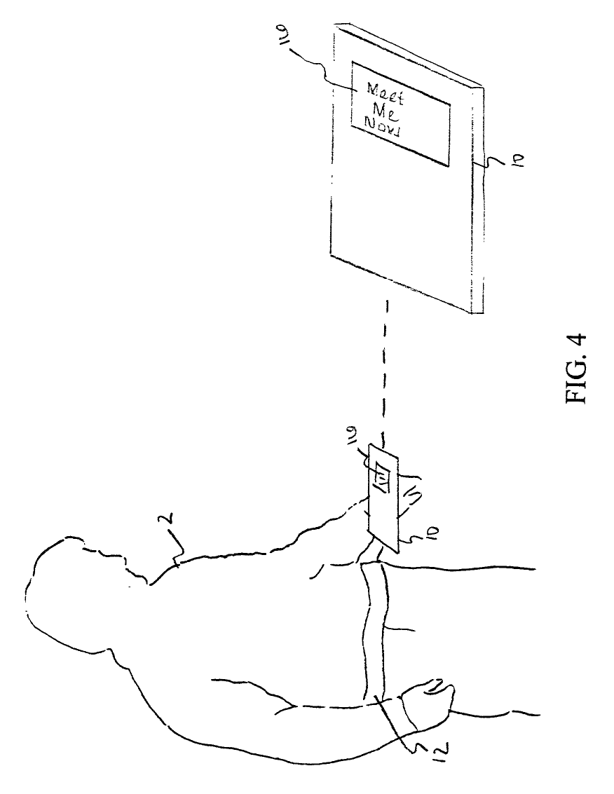

Referring now to the figures, and in particular to FIG. 3, the portable device 10 capable of allowing the user to easily read the messages on the receiver according to an exemplary embodiment of the present invention is shown. The portable device 10 contains a receiver 20; a decoder 22; a processor 24; a random-access memory (RAM) 26; a mercury sensor 28; a mercury switch 30; a display unit 32; and, an alert unit 34. The display unit 32 comprises a liquid crystal display (LCD) 16 , as shown in FIG. 4, which is located on the front panel for displaying messages thereon. It should be noted the portable device 10 within the context of this disclosure includes a pager, a mobile phone, and other mobile computer devices, such as a personal digital assistant (PDA), a personal communication assistant (PCA), an electronic organizer, or any duplex interactive devices. In addition, the chosen embodiment of the present invention is a software program executing within the portable device 10. Programs are stored in the random access memory (RAM) 26. Such programs, when executed, enable the portable device 10 to perform the function of the present invention as discussed herein. Alternatively, control logic could replace the functionality of the software program.

In operation, incoming signals encompassing number and text messages are received by the receiver 20. Under the control of a central processing unit (CPU) 24, the receiver 20 demodulates the received signals to generate decoded text messages. Upon reception of the decoded messages, the CPU 24 causes the display section 32 to display the decoded messages. At the same time, the CPU 24 sends a control signal to the alert section 34 to notify the user of the receipt of incoming messages. Here, the alert signal, alert sound, or any notification modes, such as vibration of the portable device 10, can be used to notify the user of the received message. A mercury switch 30 is mounted inside the portable device 10. The mercury sensor 28 is triggered if the mercury inside the mercury switch 30 is tilted to a predetermined angle or experiences a predetermined longitudinal acceleration as a result of the movement of the portable device 10. An accelerometer can be used as the mercury sensor 28. It is noted that mercury switches are commonly known and the details of such a switch will not be described here. To reduce the effect of mercury sensor 28 causing false alarms, the CPU 24 is preferably programmed to interpret the signals in a suitable manner. Such concept known as “de-bouncing” etc., are well known in the state of the art. The CPU 24 identifies whether the mercury switch 30 becomes activated and then sends a switch signal to cause the display section 32 to change the orientation of the text messages and display inverted messages. Changing orientation in the LCD 16 is well known in the art that can be performed in a variety of ways.

With reference to FIG. 4, a user 2 is wearing a waist belt to which the portable device 10 is attached. Upon receiving a message, the user 2 would typically pick up the portable device 10 at a certain angle and look down at the display section 16 to view the displayed message. Then, the mercury of the mercury switch 30, as described in the preceding paragraphs, would trigger the portable device 10 to display the received message on the display section 16 in an inverted format. Hence, the inverted message can be seen, as a normal, non-inverted message to the user 2. Thus, the user 2 does not need to remove the portable device 10 from his waist belt to view the displayed message. It should be noted that-any number of commercially or publicly available holding means to attach the portable device 10 around the user's body can be utilized in various implementations in accordance with the preferred embodiment of the present invention.

As is apparent from the foregoing, the present invention has an advantage. The portable device 10 can determine whether the user is looking down to check the received message and provide a user to read the message easily, by displaying the non-inverted message through changing the orientation of the received message upside down.

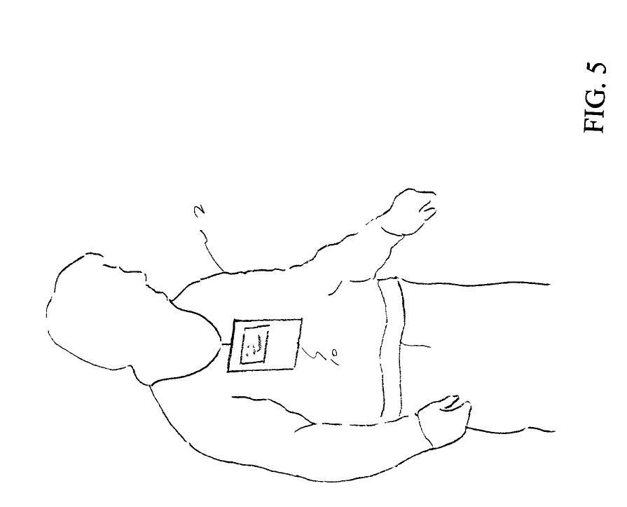

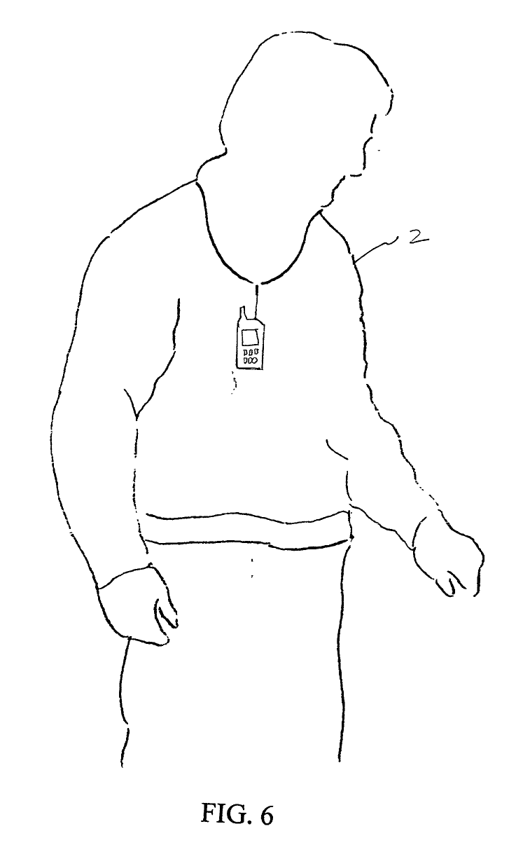

It should be noted that many modifications may be made to adapt to a particular situation and the teaching of the present invention without departing from the central scope. FIG. 5 depicts another embodiment of the present invention. Here, the construction and operation of the second embodiment are essentially the same as those described above with respect to FIGS. 3 and 4. The only notable difference is that the portable device 10 is provided to a neck holding means. FIG. 6 is also another embodiment to which the present invention is applicable. A cellular phone may be attached to the neck holding means or around the waist belt of the user 2.

While the preferred embodiments of the present invention have been illustrated and described, it will be understood by those skilled in the art that various changes and modifications may be made, and equivalents may be substituted for elements thereof without departing from the true scope of the present invention. Therefore, it is intended that the present invention not be limited to the particular embodiment disclosed as the best mode contemplated for carrying out the present invention, but that the present invention include all embodiments falling within the scope of the appended claims.

What is claimed is:

1. A portable device comprising:
means for storing a message;
means for displaying information contained in said message;
means for detecting if said device is tilted over a predetermined angle; and,
means for controlling said display means to display an inverted display of said received message if said device is tilted over said predetermined angle.

2. The portable device of claim 1, further comprising a means of receiving an incoming signal representing said message.

3. The portable device of claim 1, further comprising an alert means for notifying said user of the reception of said incoming signal.

4. The portable device of claim 1, wherein said detecting means comprises a mercury switch.

5. The portable device of claim 1, wherein said detecting means is an accelerometer.

6. The portable device of claim 1, wherein said portable device is detachably coupled to the body of said user.

7. The portable device of claim 1, wherein said oportable device is detachably coupled to/from a waist holding means of said user.

8. The portable device of claim 1, wherein said portable device is detachably coupled to/from a necklace-type holding means of said user.

9. A portable device for enabling a user to read an incoming message easily, comprising:
a receiver for receiving an incoming signal;
a decoder coupled to said receiver for decoding said incoming signal to provide a decoded message;
a processor coupled to said decoder for providing a control signal and a alert signal in response to the reception of said incoming signal;
a sensor coupled to said processor for providing a switch signal if said device is tilted over said predetermined angle; and,
a display section coupled to said processor for displaying said decoded message in response to said control signal and for displaying an inverted display of said decoded message in response to said switch signal.

10. The portable device of claim 9, further comprising an alert section coupled to said processor for notifying said user of the reception of said incoming signal.

11. The portable device of claim 9, further comprising a mercury switch coupled to said sensor for notifying that said device is tilted over said predetermined angle.

12. The portable device of claim 11, wherein said sensor produces said switch signal according to the movement of mercury inside said mercury switch.

13. The portable device of claim 9, wherein said portable device is detachably coupled to the body of said user.

14. The portable device of claim 9, wherein said portable device is detachably coupled to/from a waist holding means of said user.

15. The portable device of claim 9, wherein said portable device is detachably coupled to/from a necklace-type holding means of said user.

16. The portable device of claim 9, wherein said sensor produces said switch signal according to the movement of mercury inside said mercury switch.

17. A method for allowing a user to easily read an incoming message on the display section of a portable device, the method comprising the steps of:
(a) receiving an incoming signal representing a message;
(b) demodulating said incoming signal to produce a decoded message;
(c) determining whether said device is tilted over a predetermined angle; and,
(c)(i) displaying said decoded message on said display section if said device is not tilted over said predetermined angle; and,
(c)(ii) displaying an inverted display of said decoded message if said device is tilted over said predetermined angle.

18. The method of claim 17, further comprising the step of: notifying said user of the reception of said incoming signal.
